(19) United States
(12) Patent Application Publication
(10) Pub. No.: US 2013/0132623 A1
(43) Pub. Date: May 23, 2013

(54) Method for Interconnecting Modules for High Speed Bidirectional Communications

(71) Applicants: Dennis Allen Sierk, Huntsville, AL (US); Dustin Donavon Sierk, Huntsville, AL (US)

(72) Inventors: Dennis Allen Sierk, Huntsville, AL (US); Dustin Donavon Sierk, Huntsville, AL (US)

(73) Assignee: VELOCIO NETWORKS, INC., Huntsville, AL (US)

(21) Appl. No.: 13/298,423

(22) Filed: Nov. 17, 2011

(51) Int. Cl. G06F 13/42

(52) U.S. Cl. 710/106

(57) ABSTRACT

A method for the extension of the reliable distance and improvement in reliable speed for Programmable Logic Controller high speed serial bus communications between its logic unit and input/output modules. The insertion of differential line drivers and receivers into signal lines, originally developed for IC to IC on board communications, to enable wired bus communications over tens or hundreds of meters.

### BACKGROUND

1. Prior Art

The following is a tabulation of some prior art that presently appears relevant

U.S. Patents

| Patent Number | Kind Code | Issue Date | Patentee |
|---|---|---|---|
| 5,384,769 | A | January 1995 | Oprescu et al. |
| 5,978,578 | A | November 1999 | Azarya et al. |
| 6,073,186 | A | June 2000 | Murray et al. |
| 6,222,380 | B1 | April 2001 | Gerowitz et al. |
| 6,625,163 | B1 | September 2003 | Shideler et al. |
| 7,012,450 | B1 | March 2006 | Oner et al. |
| 7,450,037 | B2 | November 2008 | Yajima et al. |

2. Background

This invention relates to a method for implementing communications between a master logic processor and a plurality of locally distributed function modules within a programmable logic controller. In particular, it relates to a method for enabling the extension of serial communications links, originally developed for communications between integrated circuits within a printed circuit board for use over a wire cable at distances up to hundreds of meters.

Within a high percentage of programmable logic controller, or PLC, applications there exists a need for product central logic and control at a convenient location and function operation or interface connections located at other locations. The ideal placement of the logic control module typically relates to ease of user access, proximity to other devices associated with a larger system, or physical space availability. The ideal placement of interface functionality is typically in close proximity to the devices which are being interfaced. Within a system, those points of interface may reside in multiple physical locations. The points of interface may also be located at some distance from the ideal location for central logic.

A second application need relates to modular design. Most PLC applications require the application of a standard intelligence unit, coupled with a plurality of optional function extension modules. These optional extension modules provide functionality and real world interface capabilities required by the application. By choice of the proper set of function modules, a very high number of different applications can be serviced.

A third factor, due to shrinking geometries of integrated circuits, is providing impetus for separating electronic circuitry from the interface connector. The electronic interface and function circuitry associated with a block of IO is typically a very compact circuit requiring a multilayer printed circuit board, or PCB. The terminal block which accepts wiring to actuators, sensors and other devices interfaced requires a large area on a double sided PCB. If the circuits are placed on the same circuit board, the PCB must be multilayer to accommodate the electronic function circuitry. There is a very large differential between the cost of multi-layer and double sided PCBs. With technology reaching a state where the majority of required PCB space is the lower cost double sided type, it is often economically advantageous to separate the design into two circuit boards, mated with connectors.

PLC Architectures

The most common automation controller found in industry is the programmable logic controller or PLC. PLCs have a programmable central logic unit, which acts on combinations of input signals, time, sequence and user program logic to determine required operational state, including required output conditions. Since applications vary widely, the actual input and output interface electronics typically are provided by plug in modules. Designs allowing the selection and insertion of a variety of input and output (IO) modules allows for tailoring the system to particular requirements of the application system.

Historically, PLCs have employed a backplane bus design, as shown in FIG. 1a. A traditional backplane bus PLC includes a central logic controller 100 with backplane bus slots 110. A plurality of IO modules can be plugged into the backplane bus slot. The traditional backplane bus provides connection 110 for power, parallel data 102, address signals 108, control signals 106 and timing 104. Standard construction of this type of a backplane consists of printed circuit board, or PCB, with parallel signal lines, connected to the same slot connection in each slot.

FIG. 1b shows a backplane bus PLC, including a logic controller 120, with IO modules 122 plugged into the slots. Each IO module typical includes a terminal strip 124 for wire connections to devices such as sensors, motors, actuators, valves and solenoids.

Such traditional backplane systems are still common in industry. By virtue of the fact that so many connection lines are required, this type of bus is expensive and inflexible.

Implementation of Serial Busses in PLC Architectures

High speed serial communications links for integratated circuit to integrated circuit (IC to IC) have been developed and implemented by semiconductor manufacturers over the last two or three decades. One such link, Inter IC Communications bus or I2C was introduced by Philips Semiconductor in 1982. Another link, System Packet Interface or SPI was introduced by Motorola Semiconductor in 1979, and gained popularity in the late 1990s. Both of these communications technologies were originally intended for communications between devices, such as microcontrollers, EEPROM memory and intelligent devices found within a printed circuit board. Other, similar high speed serial IC to IC communications systems, including Microwire, from National Semiconductor and Texas Instruments' Synchronous Serial Interface, or SSI are also in common use.

The various IC to IC communications interfaces are all quite similar. An example of an SPI communications interface is shown in FIG. 2a. FIG. 2a shows a master device 140 with communication connections to a slave device 142. The master transmit data 150 transmits serial data from the master to the serial receive data connection 158 of the slave device. Correspondingly, the slave transmit data 160 transmits data from the slave device to the master receive data connection 152 of the master device. The serial clock 154 is sent from the master device to the slave device 162 to provide synchronized bit timing for serial data in both directions. The master device issues select signals 156 to the slave device selected 164 for communications. There may be any number of slave devices. Each slave device requires an independent select signal. Data and clock signals are common to all slave devices. For an SPI high speed serial bus, communications occurs simultaneously in the transmit and receive directions. Other high speed serial busses are similar. The primary differentiation between busses is the fact that some busses communicate one direction at a time instead of simultaneously in both directions.

FIG. 2b is a timing diagram which illustrates communications over the SPI link. When the select line, SEL 170, is logic low, the slave device connected to that SEL line is selected for communications. The serial clock, SCLK 172, provides timing for serial data. Depending on the particular timing set up, the serial clock state or transition indicates the point in time each bit is clocked as valid. The remaining two signals shown are master transmit data, MTD 174, and slave transmit data, STD 176. MTD and STD are the serial data from master to slave and slave to master, respectively.

From the late 1990s to the present, some PLCs have utilized high speed serial communications, originally developed for IC to IC communications, for interconnecting the central intelligence with function modules. Use of a serial bus employing very few connections has enabled both simpler backplane bus designs and designs in which modules plug together, side by side, without the use of a backplane. The simpler backplane bus configuration is illustrated in FIG. 3a. FIG. 3a shows a traditional enclosed backplane PLC 200, with a central logic unit 202, and JO connectors 204. The difference between this type of PLC design and to one illustrated in FIG. 1 is a high speed serial bus, like that illustrated in FIG. 2. Depending on the particular bus chosen, it consists of no more that four signals that are common to all slots and one signal that is particular to a given slot.

FIG. 3b illustrates the electronic connections employed on a typical backplane bus which utilizes high speed serial communications. The signals for the logic controller master 220 and the slave device IO modules 222 are the same as previously discussed for FIG. 2. Individual SEL lines are used for the individual slots. Buffer drives 226 may be employed to improve the robustness of the signals.

FIG. 4a illustrates a high speed serial bus implemented with modules that plug together, side by side, rather than with a backplane. A side by side design implements a central logic module 300 and a plurality of IO modules 302. In this type of arrangement, each module has a socket, into which he next module can plug in, as illustrated in FIG. 4b. A connector 310, on each module plugs into a mating socket.

FIG. 4c illustrates the actual electronic connections for a side by side high speed serial bus design. As FIG. 4c shows, the primary clock 320 and data 322 lines pass from module to module on the same pins. Typically, the select 324 line used for each module is taken from the same pin as shown. The remaining select lines are rotated, so that a different select 326 line is in the active position for the next module. Since each select signal can only be used for one IO module, the limit on the number of JO modules is the number of select lines implemented.

Another implementation of the same type of bus uses I2C or similar bus. Since I2C transmits then receives on the same signal line, it can be implemented without an individual select signal per IO module. The transmit message could include an address field. The advantage of a half duplex communications link like I2C is a potential reduction in connections. The disadvantage is slower communication.

Limitations and Problems of Current PLC High Speed Serial Bus Architectures

High speed serial communications links employ standard single ended signal circuitry. Each signal line is referenced to ground. This is the signaling method for almost all signal lines on a PCB board. It is quite effective for on board connections or for very short distance connections, such as described. There are trade offs between data rates and distance for error free communications with low voltage single ended circuitry. Lower data rate communications is reliable at longer distances than higher date rate communications. Typical limits range from a few inches to tens of inches. If the data rate is low, it might range to a few feet.

The limitation of the high speed serial bus length to a short distance of inches to tens of inches means that the IO modules must all be placed in close proximity to the central logic module. Both the backplane bus and the side by side plug together module models adhere to that limitation. Either of these models makes it difficult to mate high density function and interface electronics on a multilayer PCB with large, double sided terminal strip PCBs in an economic arrangement.

In many PLC applications, the most ideal placement of function modules is distributed in space. Placement of IO modules closer to the input and output devices with which they connect would greatly reduce wiring costs, as well as improve signal quality. Placing the IO module close to the IO connection points would also greatly reduce both the material and labor expense in wiring the interconnects with the IO. The factors requiring IO modules to be placed in close proximity to the central logic and each other preclude distributing them in the most ideal placement. As a result of these limitations, more and longer wiring is utilized than might be optimal.

Some PLC manufacturers address this problem through high IO count IO modules, combined with high wire count cables to a connector module. An example is illustrated in FIG. 5. The IO module 350 may be located in a backplane rack or as a plug together module. The IO electronics module 350 may be several feet from the IO connector module 356. For an IO module which interfaces 32 IO devices, the typical interconnect cable 354 required would be on the order of 40 wires. For an IO module which interfaces 64 IO devices, an 80 connector cable or two 40 connector cables would typically be employed. This type of design solves the requirement for larger physical space for connectors It also enables the physical distribution of IO connections. However, it does so at great expense for cabling.

Regardless whether direct IO connections are located a the site of the PLC or cabled to a remote IO connector, the cost of wire and cabling is substantial. In either of these two cases, at least one signal wire must be run from at or near the central logic module to the IO sensor or activator. In such a system, wiring is one of the highest costs in the system.

Other technologies exist for addressing distributed IO, although not commonly employed for IO distribution within a few feet. These technologies utilize communication means, such as Ethernet, Devicenet, CAN and RS422.

The reasons that the standard communications technologies just mentioned are not normally used for very short distance distribution are primarily cost, and secondarily speed related. Each communications technology comes with a cost for transceivers, connectors and microcontroller electronics. Such communications is also typically much slower than the high speed serial connections discussed. The cost of communications and the reduced system performance make use of standard communications technology distribution within short distances impractical in most cases.

### SUMMARY OF THE INVENTION

This invention creates a method for extending the practical distance for high speed serial bus operation in PLCs and similar devices. Extension of practical distance enables distribution of modules, connected to a central logic unit, over wire cables. One resulting benefit is the capability to place IO modules at a variety of points of interface. A second resulting benefit is the enhanced practicality of design with multi-layer electronic PCBs which plug into connector assemblies resident on double sided PCBs. A third benefit is a reduction in total system wiring costs.

The embodiment of the invention is the incorporation of differential line drivers and receivers into the high speed serial bus signal lines. Differential line drivers drive a balanced voltage difference signal between a pair of conductors. This is compared to the standard single line voltage level signal, referenced to a common zero, which is utilized in standard high speed serial bus technology.

The insertion of differential line drivers and receiver into the high speed serial bus signal lines extends the practicle error free distance for communications from inches to hundreds of meters.

### DRAWINGS BRIEF DESCRIPTION

FIG. 1a shows a backplane bus programmable logic controller or PLC, with no IO modules inserted.

FIG. 1b shows a backplane bus PLC with IO modules inserted.

FIG. 2a show the signal connections for an SPI communications link.

FIG. 2b shows a data transfer timing diagram for a high speed serial data link.

FIG. 3a shows a backplane bus implemented with a high speed serial data link

FIG. 3b shows the electrical connections utilized in a typical high speed serial bus.

FIG. 4a shows a side by side plug together high speed serial bus system

FIG. 4b shows the individual modules of a side by side high speed serial plug together system

FIG. 4c shows the electronic signal connections of a side by side high speed serial plug together system.

FIG. 5 shows a PLC IO module connected to a terminal block module with a high wire count cable.

FIG. 6a shows a wire cable connected differential signal high speed serial system

FIG. 6b shows the electronic signal connections of a differential signal high speed serial system

FIG. 7a shows a wire cable connected differential signal high speed serial system that connects from IO module to IO module

FIG. 7b shows the electronic signal connections of a differential signal high speed serial system that connects from IO module to IO module

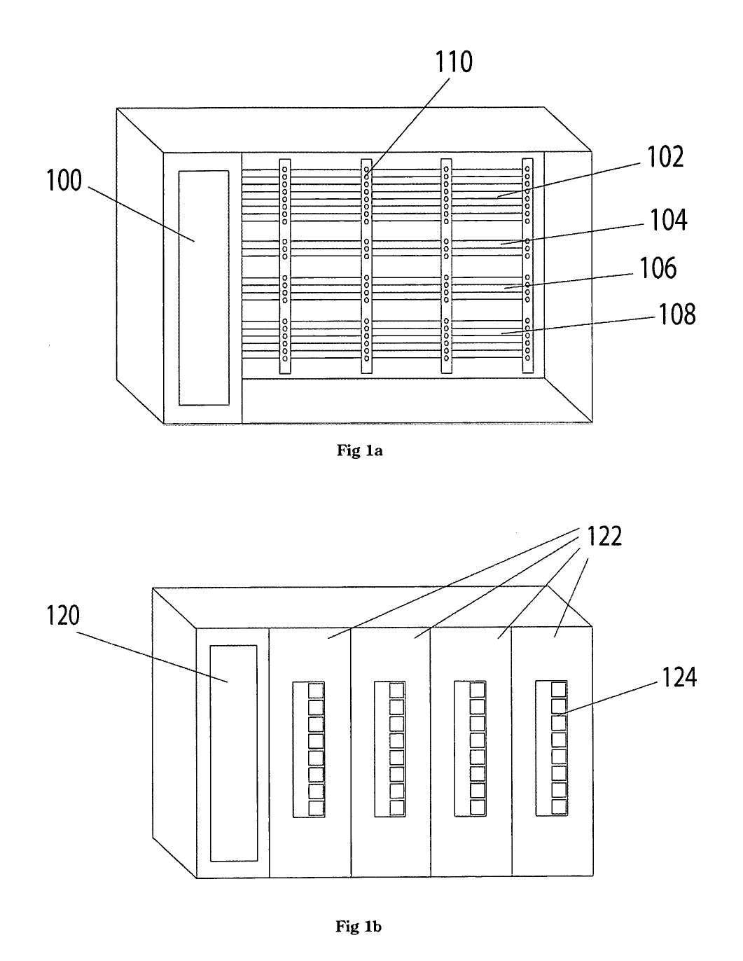

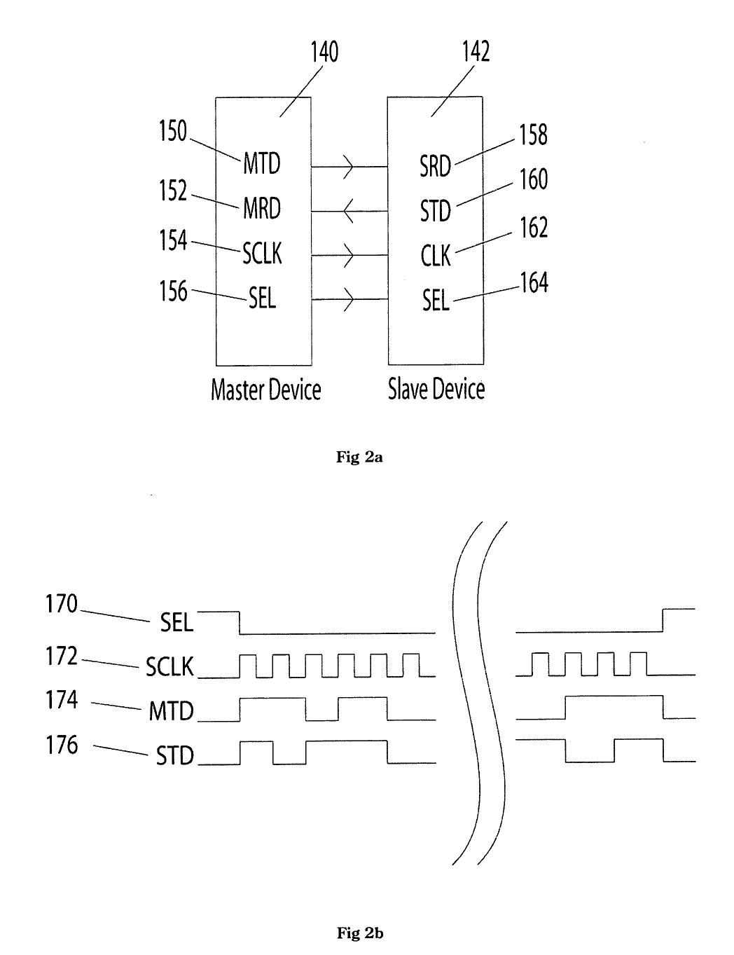

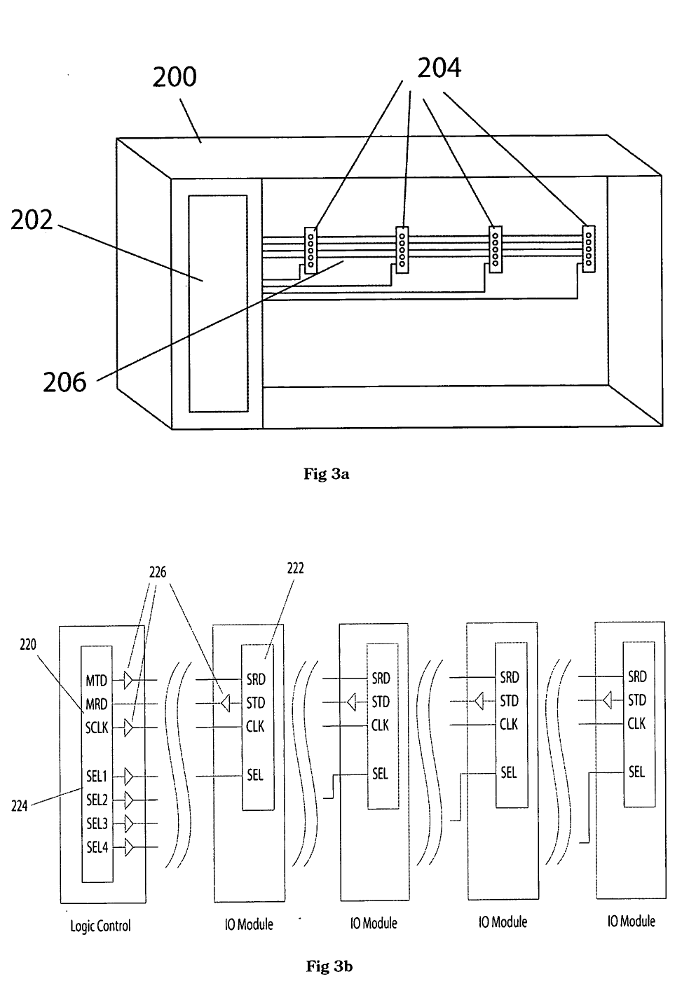

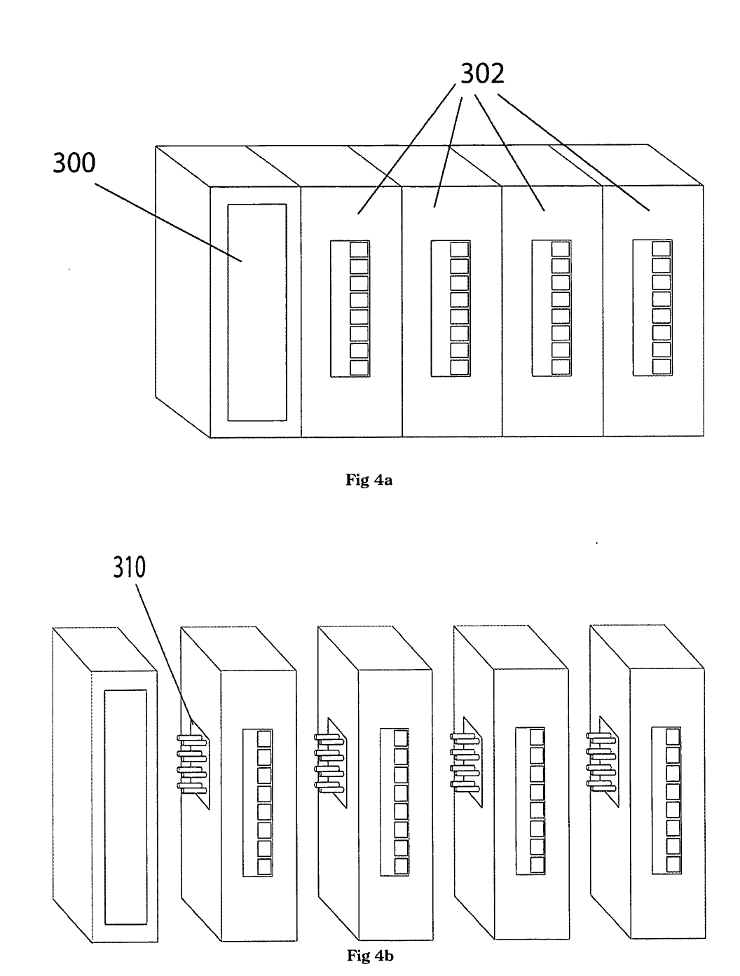

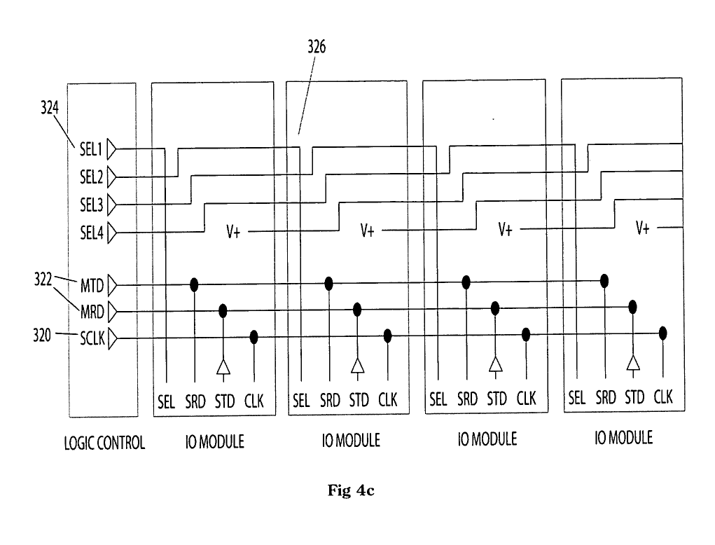

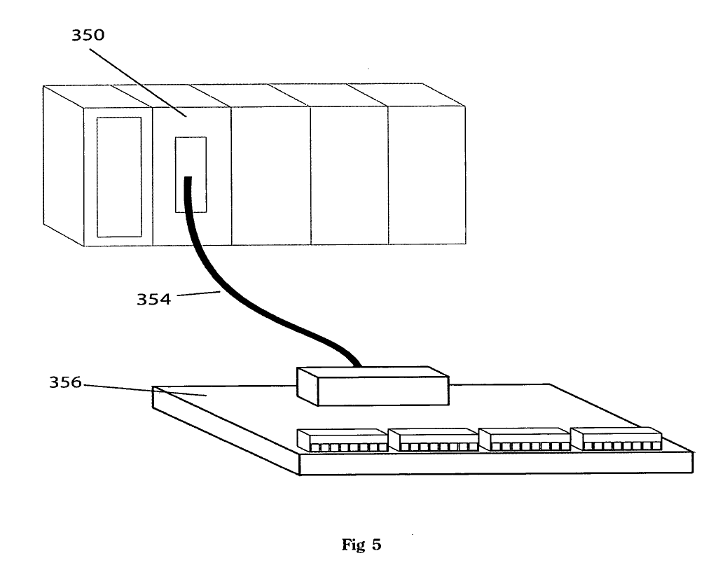

### DETAILED DESCRIPTION

The present invention relates to a method and apparatus for extending the distance limit for high speed serial communications between a programmable logic controller logic module and a plurality of IO modules. In the following description, numerous details are set forth such as specific serial busses, line driver technologies and configurations. However, it will be apparent to one skilled in the art that the present invention may be practiced with other high speed serial bus technologies and other differential line drivers.

Differential drivers and receivers have long been used in standard communications technologies, including RS422, RS485 and CAN. In 1962, RS232 communications was introduced as a standard computer serial communications interface technology. RS232 uses single line voltage level signals, referenced to a common signal ground, similar to standard high speed serial bus technologies. RS422, RS423, and RS485 were later introduced to enable longer distance, higher speed and multidrop capability to serial communications. Each of these technologies simply replaced the single ended RS232 transmit drivers and receivers with differential transmit drivers and receivers. The table below illustrates the speed and distance improvements achieved with the change in drivers and receivers. The difference between RS232 and RS422 is exclusively the difference in the line drivers and receivers used.

| | |
|---|---|
| RS232 | RS422 |

| | | |
|---|---|---|
| Maximum # drivers | 1 | 1 |
| Maximum # receivers | 1 | 10 |

| | | | | |
|---|---|---|---|---|
| Max distance | 15 | meters | 1200 | meters |
| Max speed at 12 meters | 20 | Kbs | 10 | Mbs |

As the table illustrates, application of differential line drivers provides for a dramatic improvement in both the data rate and the distance that a message can be reliably transmitted. What is not obvious is that RS232 maximum distance is rated as high as it is because RS232 uses relatively high voltage signaling, up to +/−15 volts. The high speed serial busses, such as SPI and I2C are designed for low voltage signals, less than 5 volts.

The present invention applies differential line drivers and receivers to the high speed serial bus signal lines. Drivers and receivers designed for RS422, RS423 and RS485 may me used. Other potential technologies are the line drivers and receivers used for LVDS. Low Voltage Differential Signaling, or LVDS, is the IC technology used in Firewire, video display interfaces and other applications. Another technology that could be uses is the IC technology used in Transition Minimized Differential Signaling, or TMDS. Whichever current or future differential driver/receiver technology is utilized, the key is that it is differential. Differential drive signals extend the practical distance and increase practical data rates by reducing the electrical noise in the signal path.

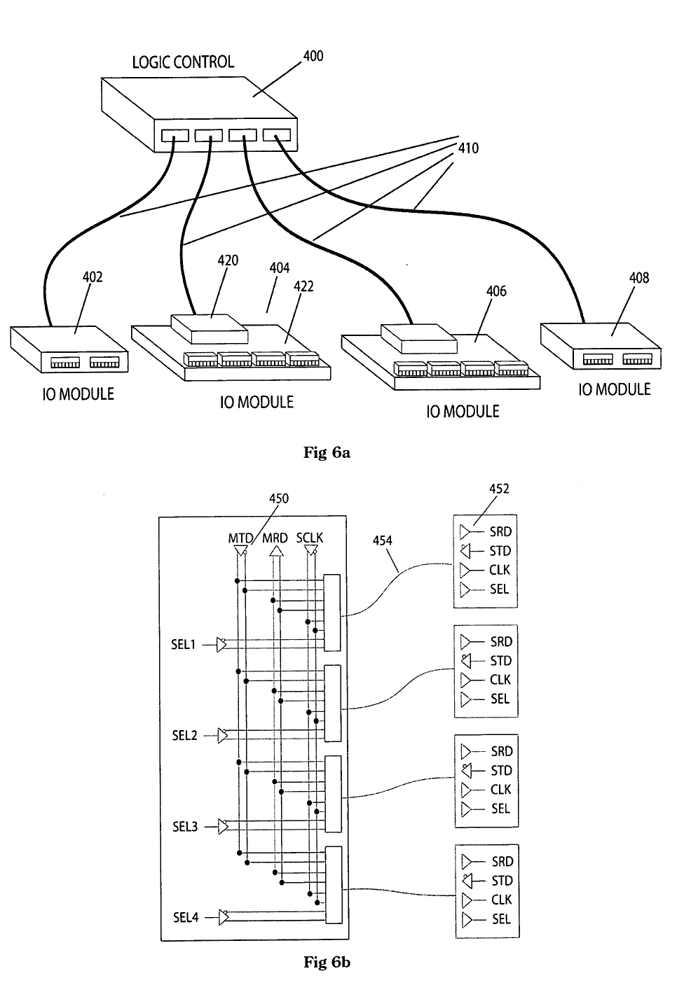

The first embodiment of the invention is shown in FIG. 6a. Logic controller 400 is connected to a plurality of input/output and function modules 402-408. The logic controller is connected to each of the IO and function modules with an individual wire cable 410.

FIG. 6b illustrates the electronic connections employed in the first embodiment. Differential line drivers 450 are placed on the transmit side of each signal. Corresponding differential receivers 452 are placed on the receive side of each signal. Between the transmit and receive points is a pair of wires for each signal. In the first embodiment of FIG. 6a a separate cable 454 connection for each IO module contains only the signals associated with the particular IO module.

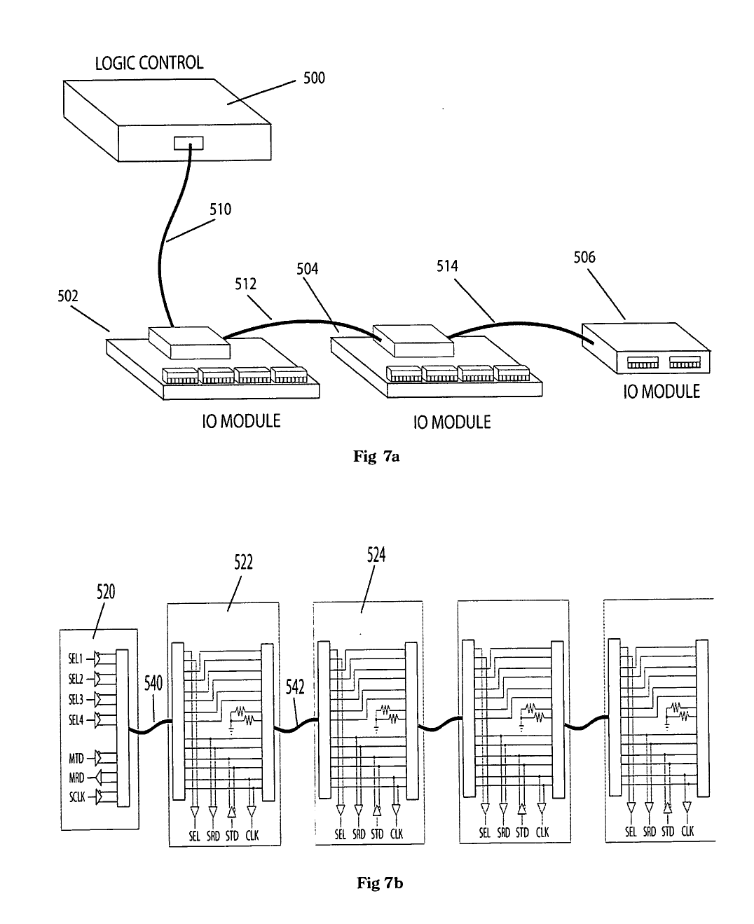

The second embodiment is shown in FIG. 7a. One cable is connected from the logic control module 500 to the first IO module 502. Each subsequent IO module, 504 then 506, connects to the previous IO module. FIG. 7b shows the electronic signals associated with the second embodiment. The logic control module 520 is connected through a wire cable 540 to the first IO module. A second cable 542 connects the first IO module to the second IO module 524. This cable connection to the next IO module is done successively for as many modules as are present. As FIG. 7b illustrates, all data, clock and select signals are contained in each cable. Select signal rotation, in the IO modules, keeps the select signal for each module on the same set of connection pins and unique to that module.

Both the first and second embodiments of the invention illustrate use with SPI communications used as the high speed serial communications bus. In both embodiments, individual select signals are utilized for each IO or function module. In this arrangement, the select line is used to signal which module is active in communications. Alternatively, a common select line could be utilized. If a common select is utilized, message content would be required to select the module active for communicating each message.

FIG. 6b and FIG. 7b illustrate that the clock SCLK, master transmit data MTD, and the slave transmit data STD are common to all modules. That is not an issue for SCLK and MTD, since these signal go from the logic controller to all slave IO modules. It is an issue for the STD signals. Since all IO modules are connected to drive the same pair of conductor wires, there is the potential for interference. The solution for an SPI bus is the use of the select signals and standard differential driver functionality found in line drivers for RS422, RS423 and RS485. Each of these driver types implements an enable signal. If the driver is not enabled, it effectively disconnects. Using the select signals to activate the differential line driver enable ensures that only the device with which communications is active is driving its serial transmitter.

Any high speed serial communications link could be used in the embodiment of the invention. Examples of high speed serial communications links that could be used include SPI, I2C, Microwire and SSI.

Both embodiments illustrate the invention utilizing a small electronic function module, shown as item 420 in FIG. 6a, built on a multi-layer PCB, in combination with a large terminal block module, shown as item 422 in FIG. 6a, built on a double sided PCB. The extended distance enabled by the use of differential drive circuitry allow the implementation of the split design. The electronic function or IO module connects to the terminal block module through direct connection.

What is claimed is:

1) A method for extending the reliable operating speed and distance for Programmable Logic Controller serial bus communications from a central logic unit to input output and special function modules by use of differential line drivers and receivers comprising:
a) placing a differential driver device in line with all transmit signals including data, clock and select signals.
b) placing a differential receiver device in line with all receive signals including data, clock and select signals.

2) A method of claim 1, wherein the Programmable Logic Controller Logic unit is connected to Input/Output modules and function modules over wire cable utilizing a pair of wires for each differential signal.

3) A method of claim 1, wherein a select signal from the Programmable Logic Controller Logic unit to the selected Input/Output module enables said Input/Output module to activate its transmit data differential line driver.
